(19) United States
(12) Patent Application Publication
(10) Pub. No.: US 2013/0178241 A1
(43) Pub. Date: Jul. 11, 2013

(54) System and method for context based user intent sensing and content or application delivery on mobile devices

(71) Applicant: Inset, Inc., Sunnyvale, CA (US)

(72) Inventors: Veerabhadra Manoj Duggirala, Sunnyvale, CA (US); Venkata Ratnam Tatavarty, Sunnyvale, CA (US)

(73) Assignee: Inset, Inc., Sunnyvale, CA (US)

(21) Appl. No.: 13/663,476

(22) Filed: Oct. 30, 2012

Related U.S. Application Data
(60) Provisional application No. 61/553,258, filed on Oct. 31, 2011.

(51) Int. Cl. H04W 4/00

(52) U.S. Cl. CPC H04W 4/003
USPC 455/550.1

(57) ABSTRACT

The embodiments of the present system includes a mobile device with a native or installed mobile application that communicates with a cloud platform for context based content delivery to the mobile terminal device. The mobile cloud platform includes a mobile cloud virtualization layer, a mobile cloud content delivery layer and a mobile cloud network layer. The mobile cloud virtualization layer functions as a storage and process center. It allocates resources for native applications and other user information storage, content storage for static services, content storage for dynamic services and runs application processes for mobile users independent of the mobile platform. The mobile cloud content delivery layer runs a context-adaptive engine that delivers service provider content to a mobile platform based on space-time context of the user. The mobile cloud network layer forms dynamic local networks as well as high frequency usage networks with other mobile terminal devices based on the user analytical data.

### CROSS REFERENCE TO RELATED APPLICATIONS

The present application claims priority under 35 U.S.C. §119 (e) to U.S. Patent Application No. 61/553,258, filed 31, Oct., 2011 and titled “System And Method For Virtualization And Dynamic Context Based Content Delivery On Mobile Platforms”, the entire disclosure of which is hereby incorporated by reference

### BACKGROUND OF THE INVENTION

The development of new technologies has been changing the known paradigm where in the early days of Internet, content access was done only by personal computers. Nowadays, different devices, such as PDAs, mobile phones, tablets, and others, are also connected to the Internet, being able to access not only web sites, but also a wide variety of content resources like eBooks, VoIP etc. Apart from these web based applications, the existing smartphones (like iPhone, Android-based devices) run various native applications that serve the specific needs of the user's day to day life. These mobile platforms are now a heterogeneous environment, with abundance of user applications. These platforms have simplified our activities by making communication and data processing faster. Content is available in seconds at the click of few simple buttons on a smartphone.

However, content delivery still relies on initial request by user and the smartphones do not currently employ the capability to provide a context based content. Current mobile systems use limited contexts to provide relevant information or services to the user, where relevancy and context, both depend on user's task. Thus there is a certain dependency for the system on user prior knowledge and experience for content delivery. In some cases the system requires user initiation and follow through, the entire process consumes significant amount of time and is not efficient. In addition, the current system does not use or combine the available online and in-store service content in providing simple and elegant solutions to the users' mobile terminal devices. In short, content delivery has become much more ubiquitous with little regard for relevancy.

There is a high demand for a system which adapts to a mobile terminal device and provides an automated, dynamic context-relevant content to that device. The system should also be able to provide fast, cross-platform functional service to the terminal device and efficiently conserve processor and storage capabilities of the mobile terminal device. In addition the system should act as a bridge between users and content provider and automatically deliver content at appropriate (desired) time and format.

A mobile terminal device's characteristics and capabilities are part of the context of a client environment where content rendering occurs. Context includes any information that can characterize an entity's situation. An entity could be a person, place, or object that is relevant to interaction between a user and an application. The user and the application themselves are such entities. Unlike human-human interaction, the distinction between implicit and explicit context information (for example, nodding the head versus saying “Yes, I will drive you to the bank”) is blurred or irrelevant for human-machine interaction because of the semantic gap between machines and humans. Instead, the concepts of qualitative and quantitative context information are more applicable. Throughout his application, a system is defined as context aware if it uses contexts to provide relevant information or services to the user, where relevancy depends on detecting, interpreting, and responding to contexts. The detection process depends on space-time context as well other sensor, network and user analytics of the terminal device.

### BRIEF SUMMARY OF THE INVENTION

The present invention disclosed herein relates to mobile communication, and more particularly, to a platform structure for the mobile communication and a mobile terminal device including the same.

The invention constitutes the development of cloud server based virtual services on mobile phones that would provide context relevant (location, speed of movement, time, reminders, email content, websites, frequency of usage and other personalized analytics of the user) content delivery, mobile to mobile networking and real-time sharing across mobile platforms.

This invention provides mobile device users/consumers an ability to get contextual information, functionalities to their needs and also provides a real-time communication between dynamic networks of the user. The application does the above mentioned actions by communicating with a cloud server based platform. The cloud platform runs a context-awareness engine (described below) that automatically detects the user context and delivers appropriate content through the application to the user's mobile phone. The content to the mobile device can be extracted from the content provider/service data or through the user resources virtualized on the cloud platform.

The cloud platform also provides forms dynamic local/custom networks with other mobile users based on location and the communication frequency of those other mobile phone users.

In essence, the cloud platform provides the following things: Platform for hosting services tailored for different contexts, Platform for data communication between users and content providers, Platform for data communication with multiple mobile users, Context detection system that evaluates and responds to user context needs with instantaneous inputs, Platform for secure e-commerce gateways for payments, Platform for storage of user content and runs applications for mobile users.

### Application Delivery

The accessibility to the application can be provided by either downloading the application or using the existing application already embedded on the mobile device or using the application through a web-based application. This is most commonly accomplished through an Internet/data enabled device (typically a smartphone or a tablet). Once installed the applications collects data from the mobile device and uses it to form connection with the cloud platform. Apps that can be streamed are those that are not already available on the device locally and their resources are present at a known remote repository.

### BRIEF DESCRIPTION OF THE DRAWINGS

FIG. 1 depicts different layers that provide functional response.

FIG. 2A is the illustration of a schematic showing different elements stored in the cloud platform.

FIG. 2B gives a list of services provided through cloud platform.

FIG. 3 gives a list of services provided for user networks through cloud platform.

FIG. 4 gives a list of services provided for service providers through cloud platform.

FIG. 5A, 5B, 5C, 5D, 5E, 5F, 5G show some of the very common use cases for content delivery on a mobile terminal device through location and mood specific context.

FIG. 6 shows a resource adaptive context sensing algorithm

FIG. 7 shows a motion sensing algorithm

FIG. 8 shows the algorithm for backing-off and advancing sensing modules

FIG. 9 shows the algorithm for classifying sound

FIG. 10 shows the algorithm for motion tracking

FIG. 11 shows the flow involved in context gathering

FIG. 12 shows the complete list of parameters extracted from sensing

FIG. 13 shows a 3-dimensional schematic of an object with 3-axis pointing to x, y and z of Earth's co-ordinate

FIG. 14 shows the steps involved in context sensing in a mobile device

FIG. 15 shows the parameters used on the server side to extract meaningful data from mobile device

FIG. 16 shows a list of questions answered through context evaluation

FIG. 17 shows the sensors used and data gathered from mobile device to extract activity of the user

FIG. 18 shows a schematic of all states sensed from mobile device

FIG. 19 shows a table with functions used in duty-cycle algorithm

FIG. 20 shows a list of all available data providers for location sensing

FIG. 21 shows a table with energy calculations using each of the sensors on the mobile device

### DETAILED DESCRIPTION OF THE INVENTION

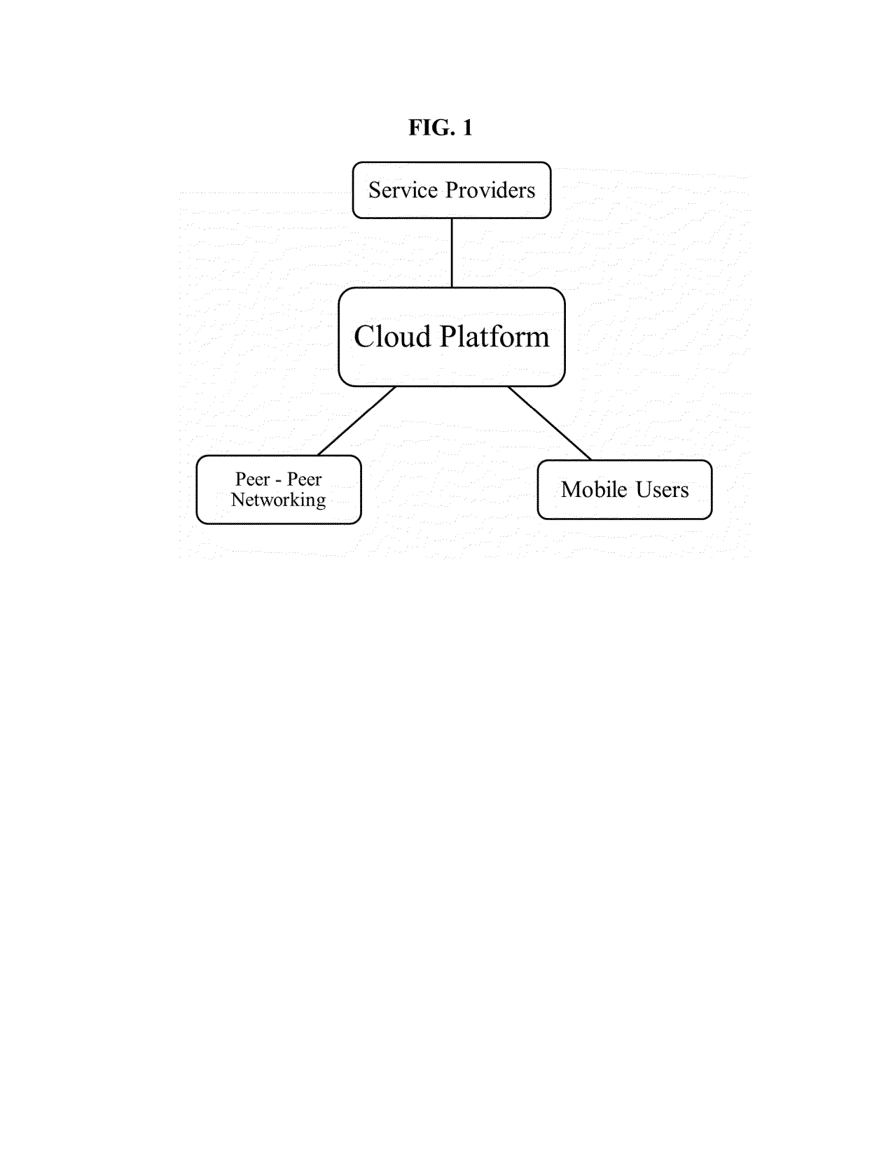

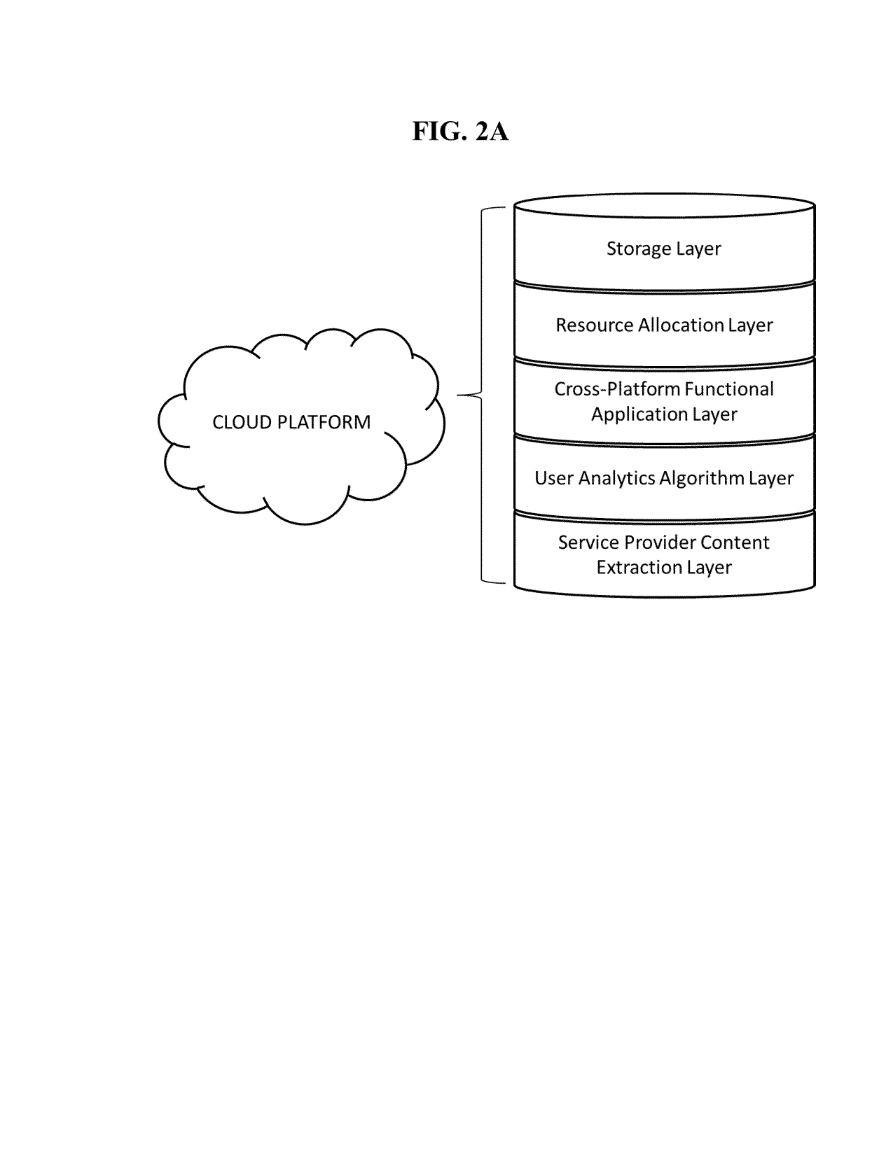

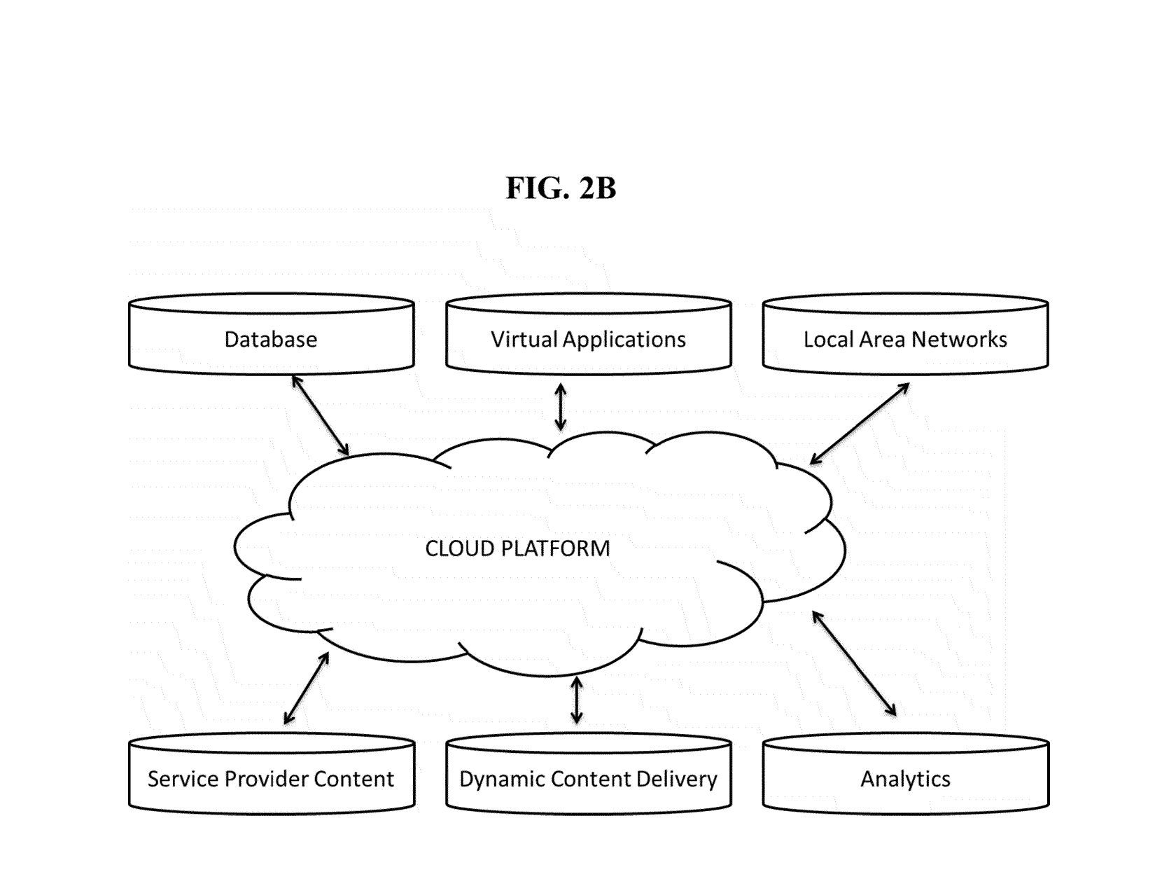

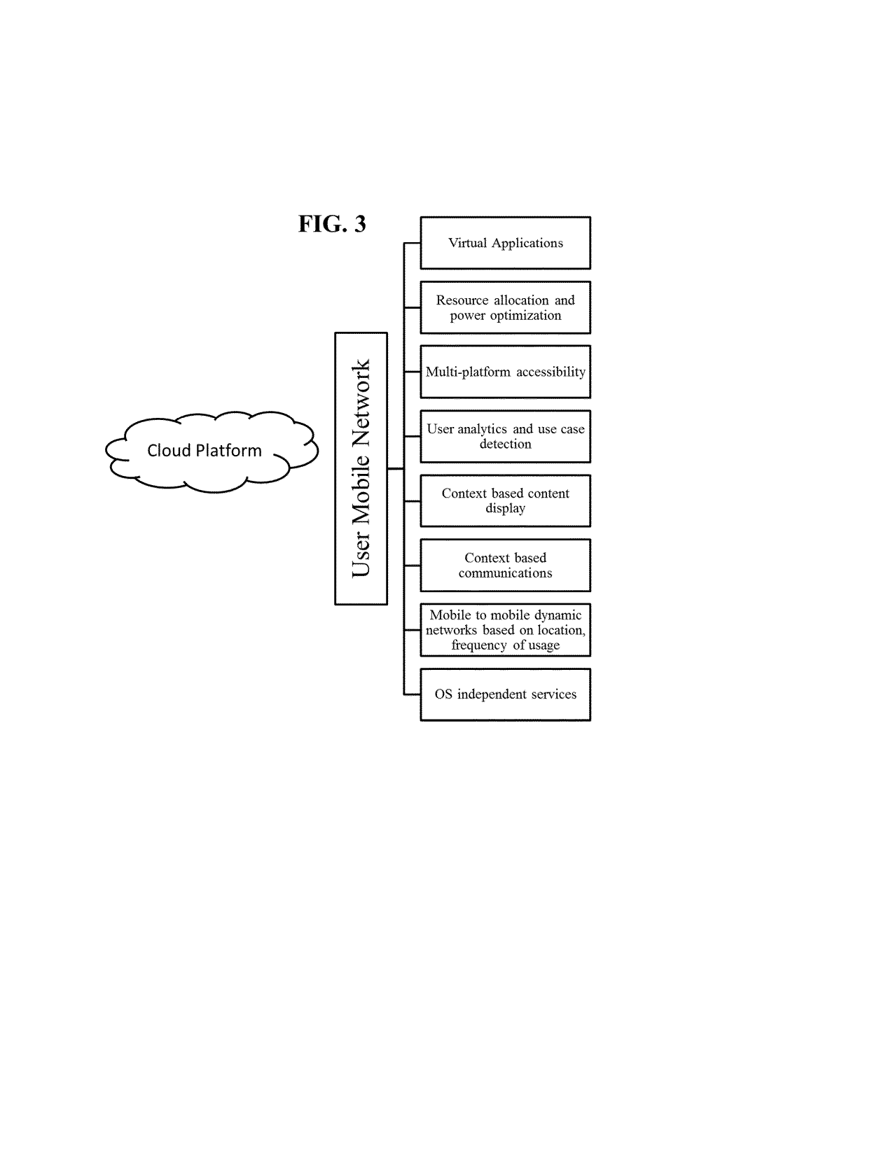

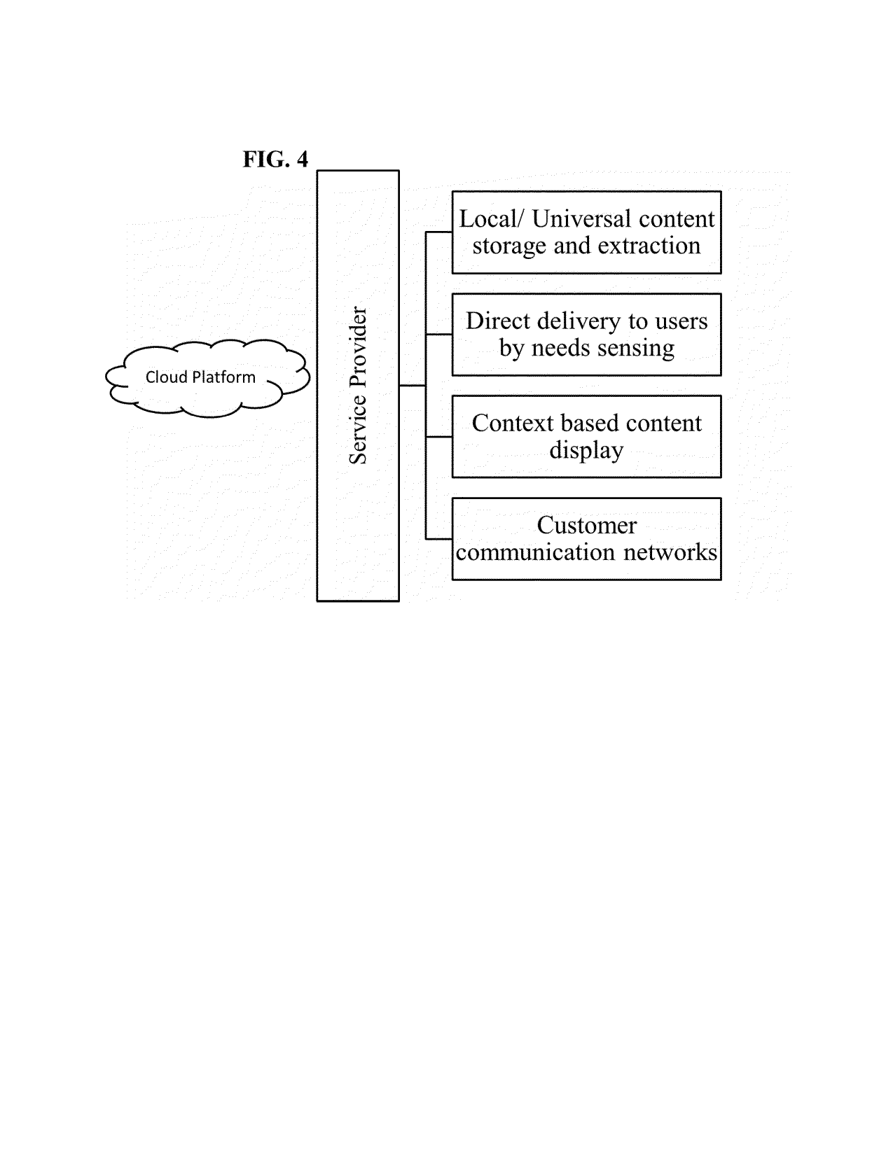

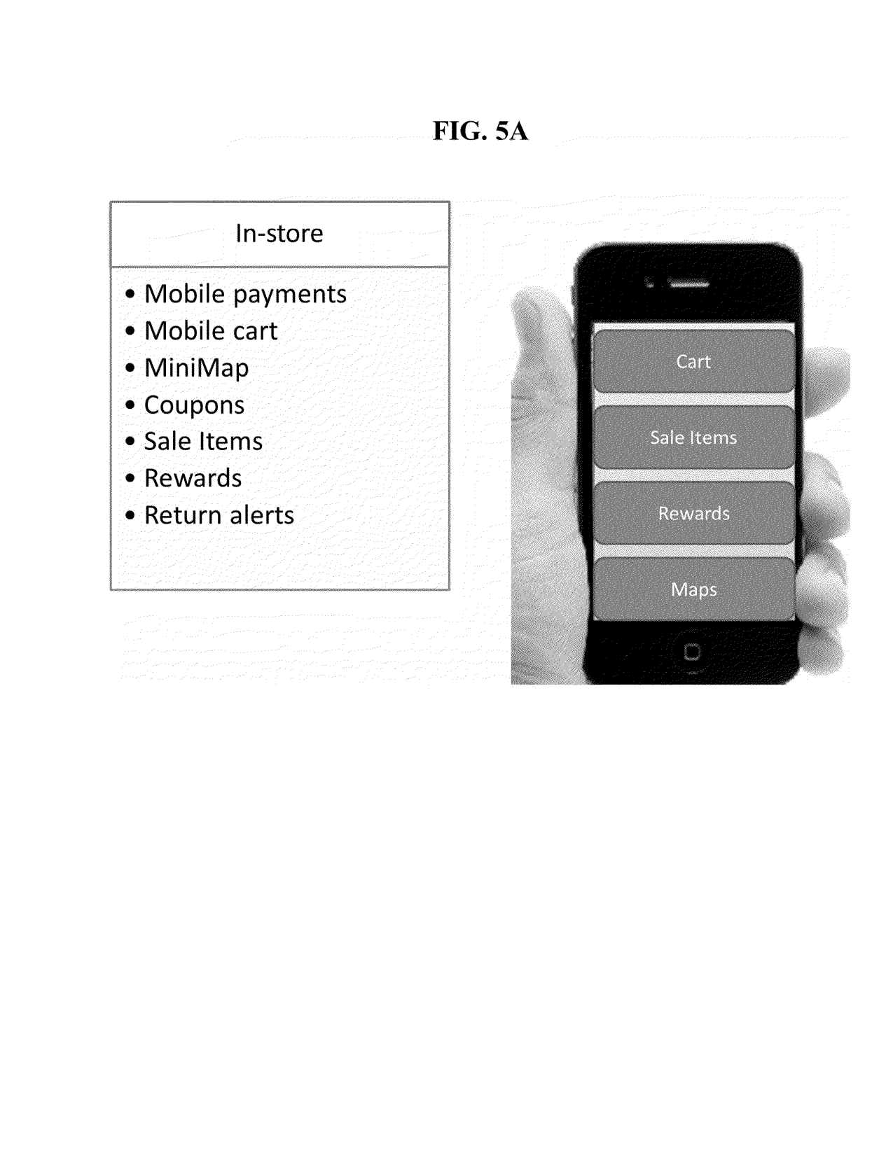

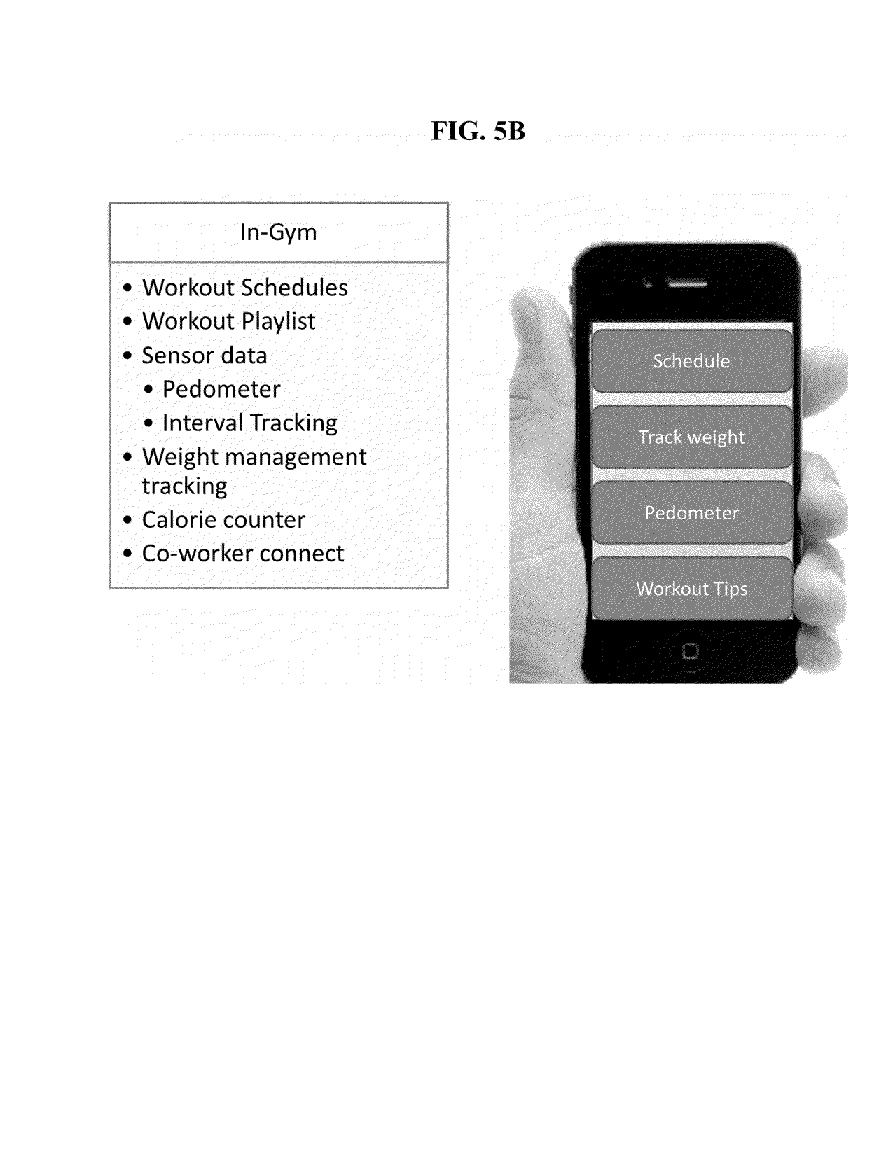

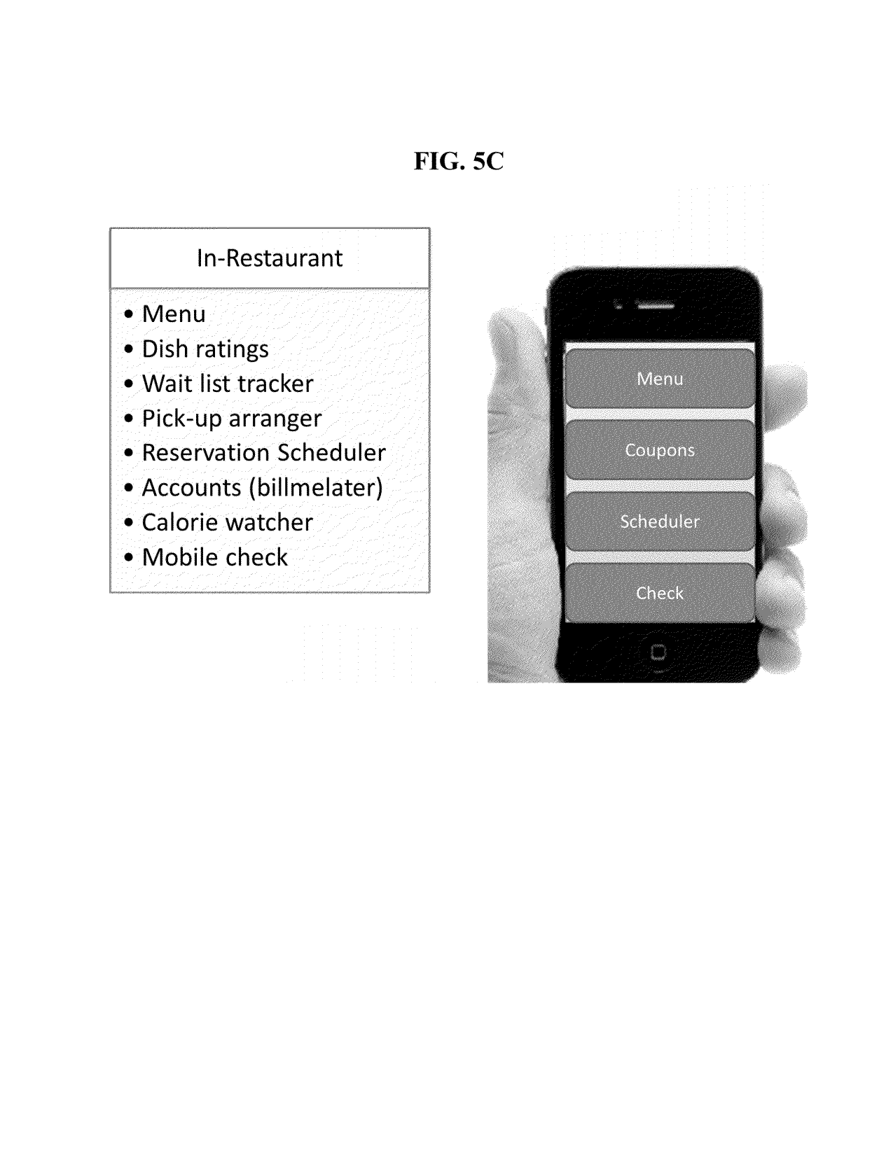

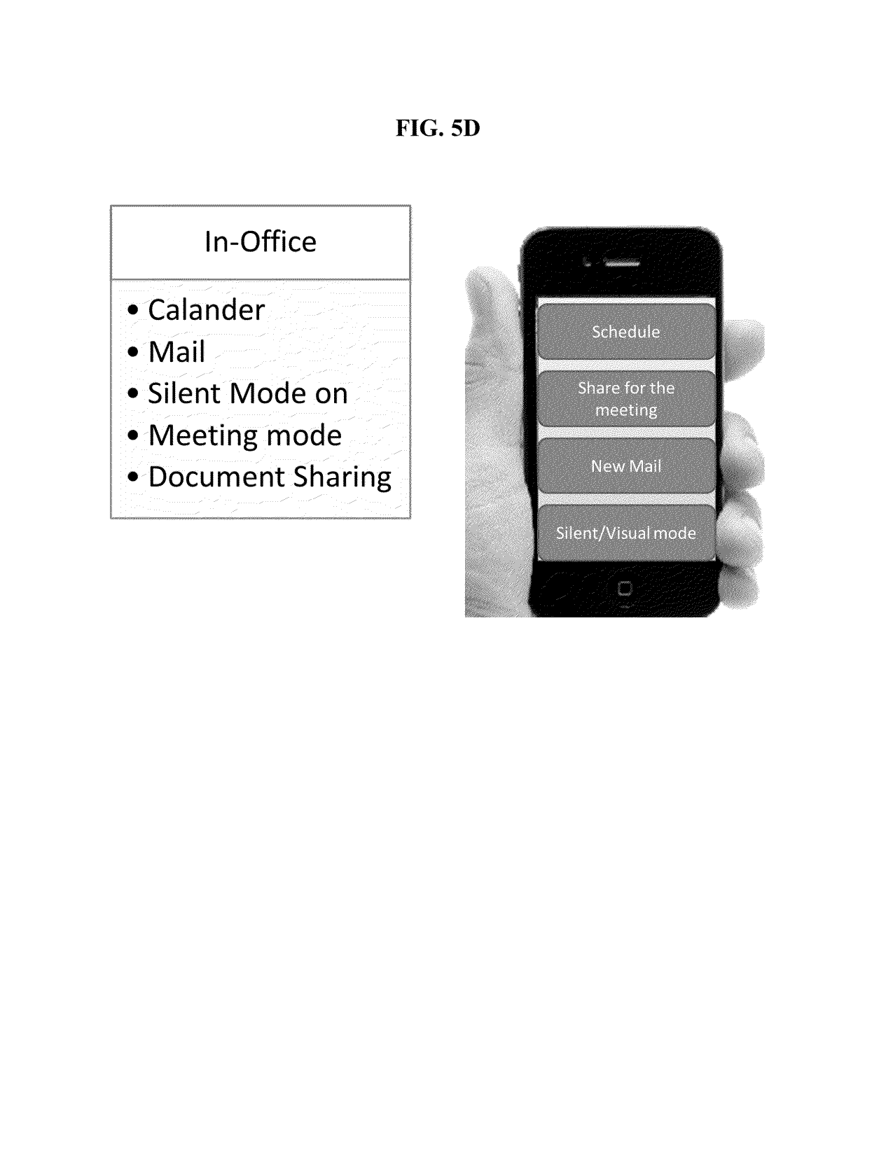

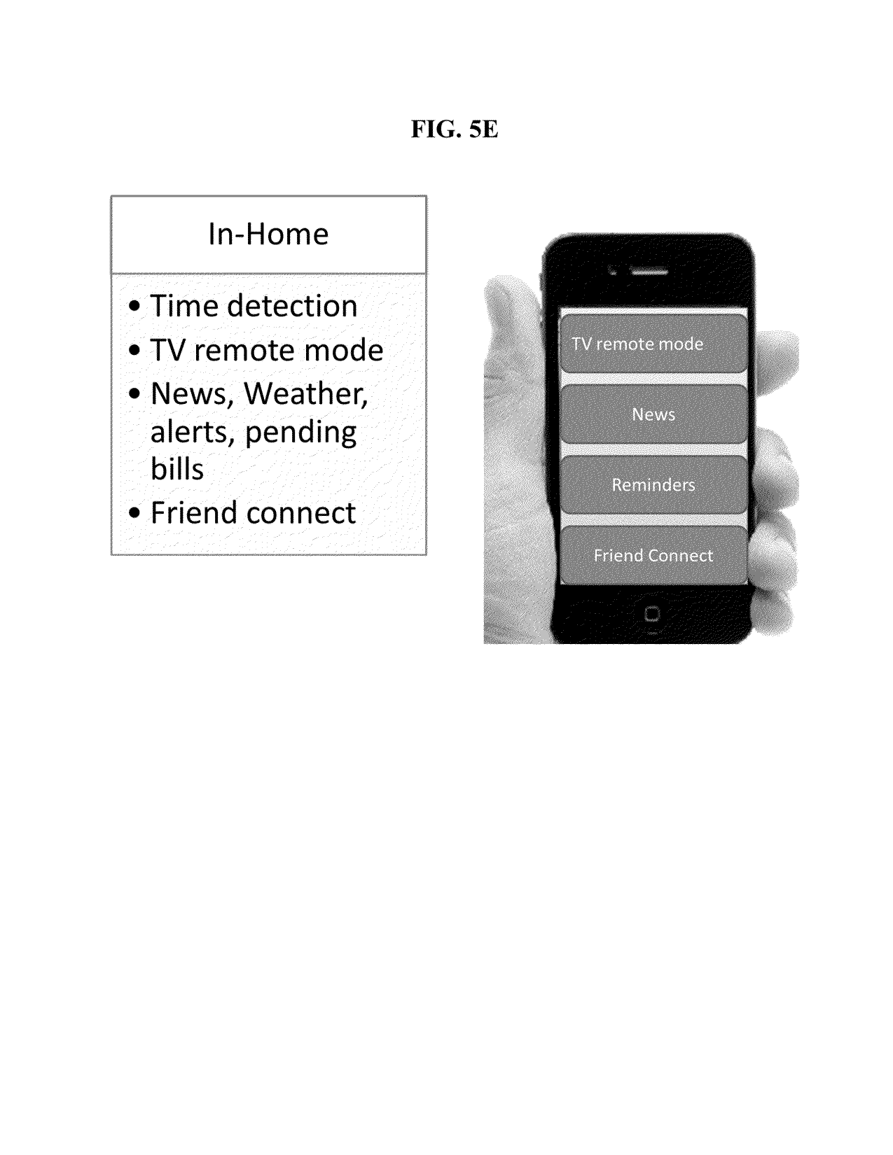

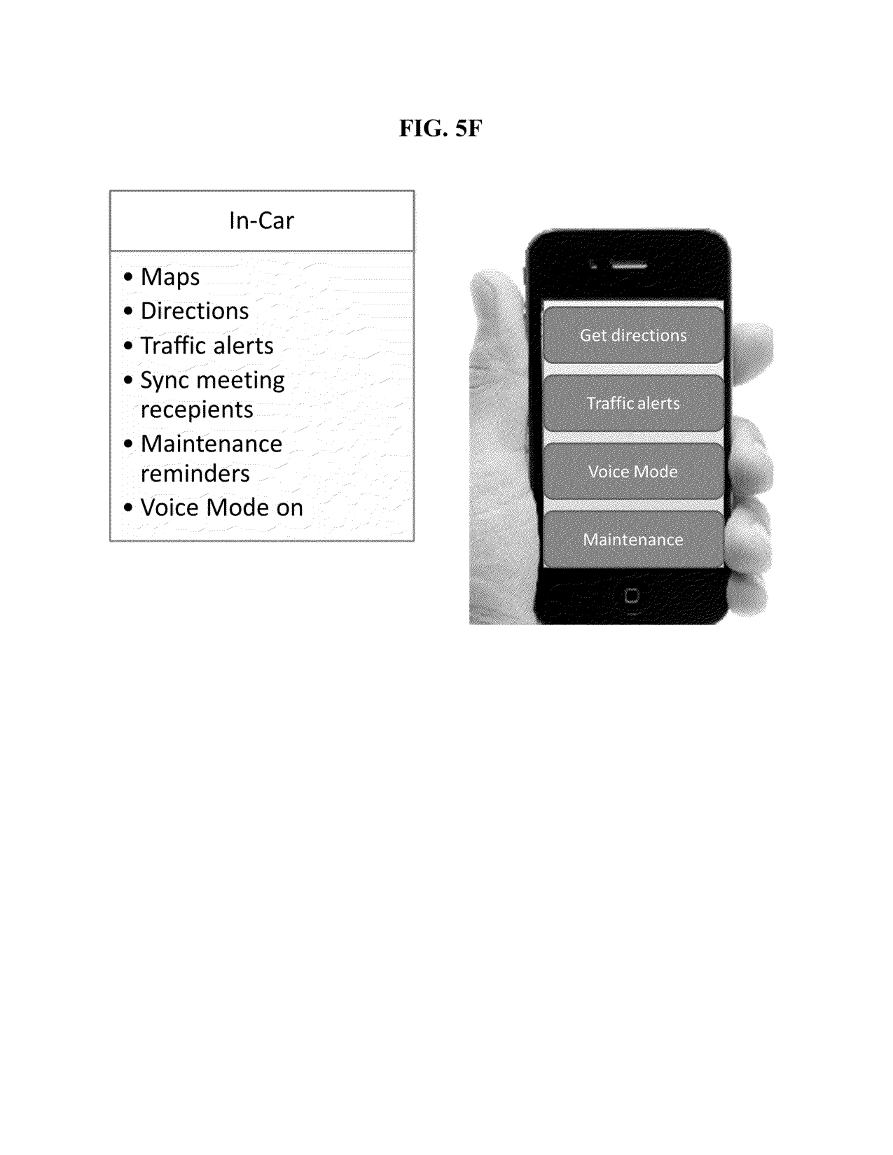

The invention comprises of combination of all the embodiments described below (as shown in FIG. 1, 2A, 2B);

The invention disclosed here provides a mobile cloud platform with/without a mobile terminal device including the same, which provide various context based services that include service, content and computing resource sharing without limiting the performance of the mobile terminal. The present invention also provides a mobile cloud platform with/without a mobile terminal device including the same, which enable communication and coordination between mobile terminals under the mobile network ecosystem, and cooperation between a server cloud and a mobile cloud and extend a mobile platform to a cloud scope of a next-generation computing service. In addition, the present invention provides a mobile cloud platform with/without a mobile terminal device including the same, which provides a content extraction of the services available in the mobile cloud network and provides content delivery system for services that respond based on user context.

Embodiments of the present system include a mobile device with a native or installed mobile application that communicates with a cloud platform for context based content delivery to the mobile terminal device. The mobile cloud platform includes a mobile cloud virtualization layer, a mobile cloud content delivery layer and a mobile cloud network layer. The mobile cloud virtualization layer functions as a storage and process center. It allocates resources for native applications and other user information storage, content storage for static services, content storage for dynamic services and runs application processes for mobile users independent of the mobile platform. The mobile cloud content delivery layer runs a context-adaptive engine that delivers service provider content to a mobile platform based on space-time context of the user. The mobile cloud network layer forms dynamic local networks as well as high frequency usage networks with other mobile terminal devices based on the user analytical data.

In some embodiments, the mobile cloud platform dynamically forms connects content service providers to mobile terminal users based on the context of space-time and other needs of the terminal device user.

In still other embodiments, the mobile cloud platform dynamically forms connects content shares (including other mobile terminal device users) to mobile terminal users based on the context of space-time and other needs of the terminal device user.

In yet other embodiments, the mobile cloud platform dynamically extracts service provider content from content provided directly to the cloud platform or through web content of the specific content provider. In yet further embodiments, the mobile cloud platform dynamically renders and delivers the service provider content making it contextually and space-time relevant to the mobile terminal user.

In other embodiments, the mobile cloud platform forms local/private networks with mobile terminal device users based on location, network usage frequency and other user analytics.

In some other embodiments, the mobile cloud platform connects the mobile terminal device with other mobile terminal devices, which may request services from each other through the mobile cloud platform network layer. In still other embodiments, the mobile terminal device and the other mobile terminal devices may mutually request services from a server cloud outside the mobile cloud through the mobile cloud platform.

In even other embodiments, the mobile terminal device and the other mobile terminal devices may form at least two mobile terminal groups in the mobile cloud.

In yet other embodiments, the at least two mobile terminal groups may form a cloud network, respectively. In further embodiments, the mobile cloud may include a plurality of mobile cloud managers that analyze the request service and control data communication of the mobile terminal device.

In even further embodiments, the mutual service requests between the mobile terminal devices and the server cloud outside the mobile cloud may be performed through at least one of the mobile cloud managers

In still further embodiments, the mobile cloud platform further may include a network layer that connects the mobile terminal device to the mobile cloud. In even further embodiments, the mobile cloud platform layer may virtualize a plurality of resources supported in the mobile terminal device and the other mobile terminal devices as if the plurality of resources is provided in one service.

In yet further embodiment, the mobile cloud service layer may perform at least one of independency processing, offline supporting, real-time data synchronization, and context management with respect to each of the mobile terminal device and the other mobile terminal devices.

In further extended embodiment, the services themselves can be hosted privately to cater a isolated set of mobile devices that require security, secrecy from the general public deployments.

In other embodiments of the present invention, mobile cloud platform virtualizes all the local resources and content available on the user terminal device to the cloud servers and allocates resources based on user context or user initiation. In yet other embodiments of the present invention, the mobile cloud platform provides accessibility to applications, contents and resources across multiple platforms irrespective of terminal device platform.

The above description is not intended to limit the service content sharing only; the method could be extended to other applications not described here.

### Context-Adaptive Algorithm

The context awareness system should mainly be able to answer two fundamental questions about the user. “Where he is?” and “what he is doing”? The system should communicate the following ‘states’ to the context matching system:

Once, these questions have been answered, the context management system would decide on the appropriate action. Each of these bins would be prepopulated as below and an appropriate sensing algorithm populates parameters into the bins.

Type of contexts desired:

Location, Surrounding environment, User State, Social networks, User emotion, Future prediction

Before we proceed any further, it is important to define what context means.

“Any information that can be used to characterize the situation of entities (i.e. whether a person, place or object) that are considered relevant to the interaction between a user and an application, including the user and the application themselves. Context is typically the location, identity and state of people, groups and computational and physical objects.” Dey A. K. & Abowd, G. D. (2000a)

Identification of context constitutes answering these basic questions:
Who?—Known, Can be deduced with adding capacitance sensory input
Where?—Location (Accurate), Location (Precise),
What?—Activity
When?—timestamp
Why?—Emotion, State, Social

Context System should be able to perform all of the following things not necessarily in the same order.
1. Recognize the person using the phone (apps adapt with user)
2. Identify the exact location the user is in
3. Identify current activity of the user
4. Identify the time of the instance
5. Identify the emotion of the user
6. Identify the ambience of the user
7. Identify the social network updates of the user
8. Identify user state—Interruptible, Active, Uninterruptible
9. Identify phone state—Vehicular, Non-Vehicular and Non-reachable
10. Identify user past actions for future task prediction
11. Identify user assigned and non-assigned tasks, perform server based computing for related tasks
12. Energy identification
13. Native auto-settings

### Parameter Query Decision Algorithm

The context awareness program involves two engines, native engine and cloud engine. Native engine is primarily a one way communicator for data acquisition. Cloud engine does all the data analysis and requests an appropriate action through the native application.

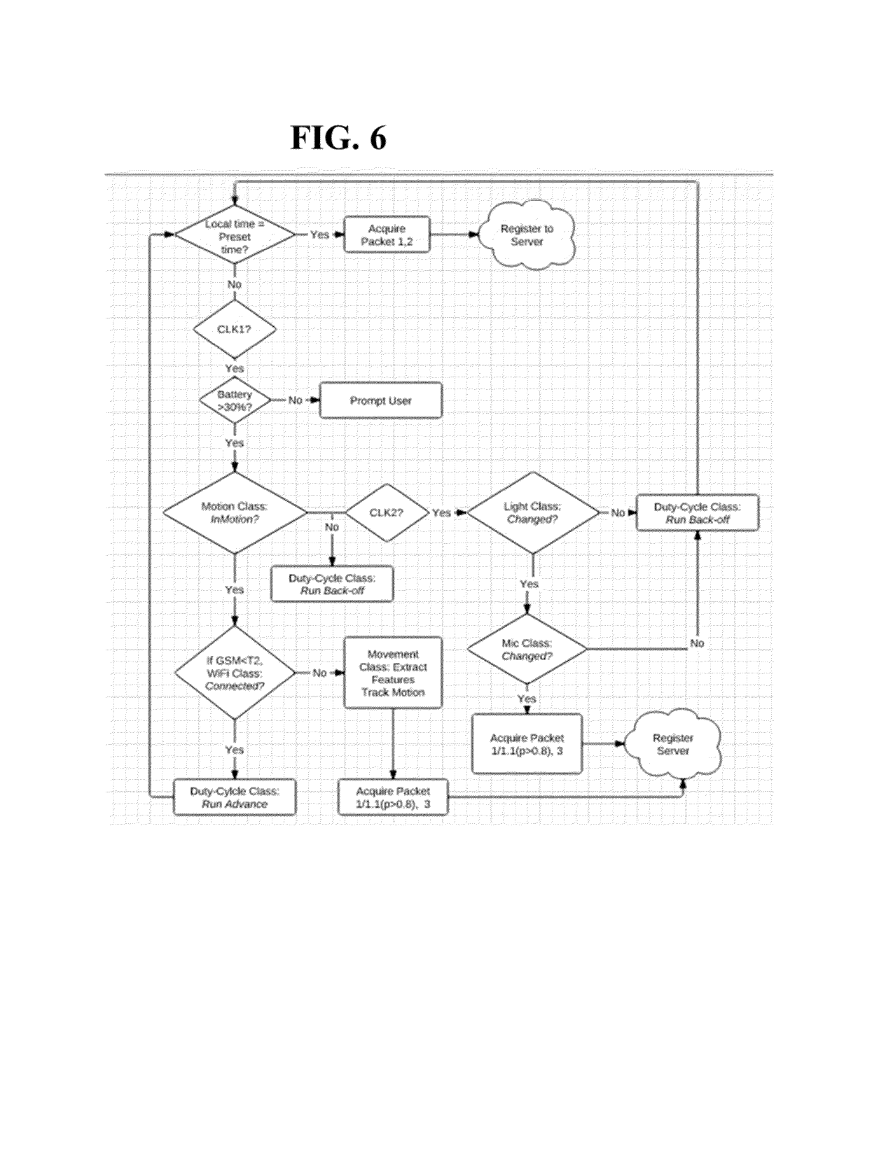

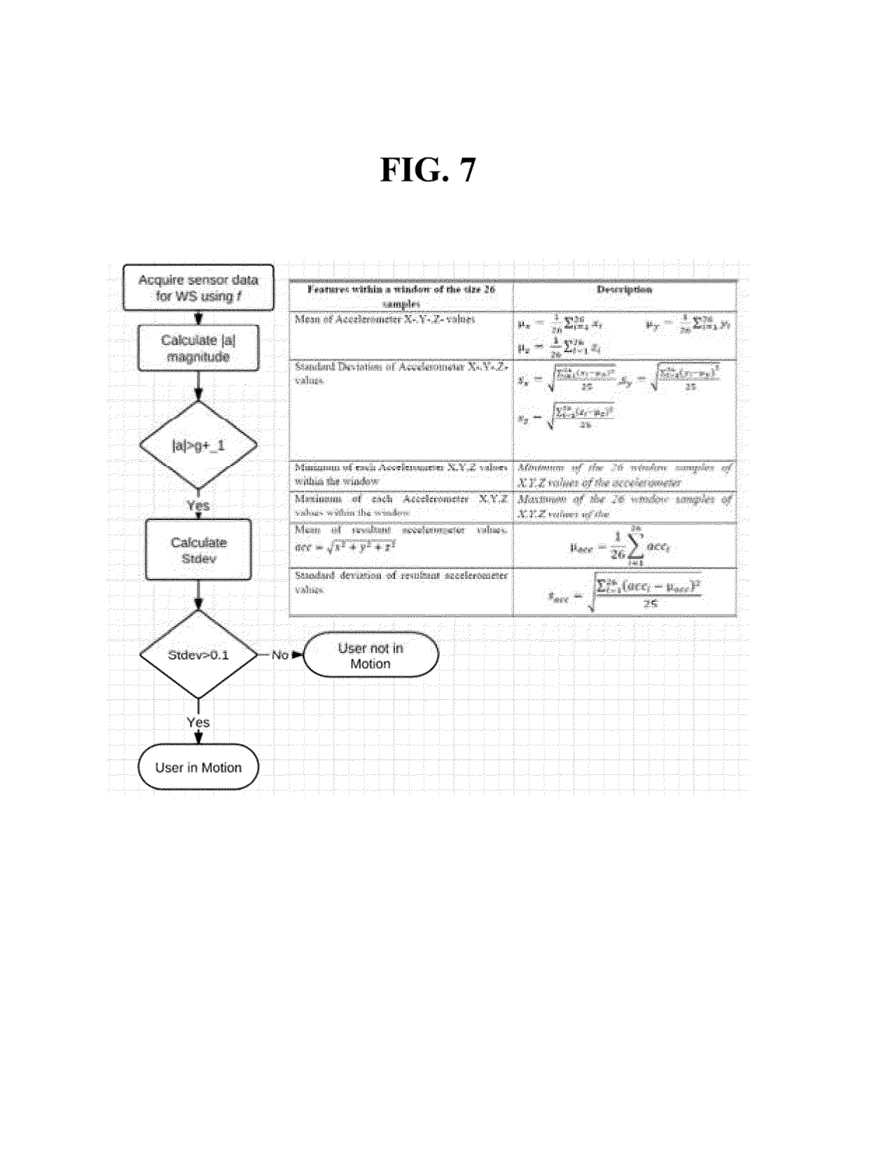

FIG.6 shows the sequence of steps that happen through the combination of the two engines.

Mobile-Native Context Sensing Algorithms

The native app would register values with server database only when there is a difference in accelerometer, noise or light. Motion tracking and place identification are the only actions done locally.

The algorithm is optimized to conserve energy without losing significant performance. Resource or battery life adaptability, mindfulness of other resource hungry app awareness are primary driving factors for algorithm executions. The estimated energy calculations with the local algorithm are as shown below:

Motion classification:

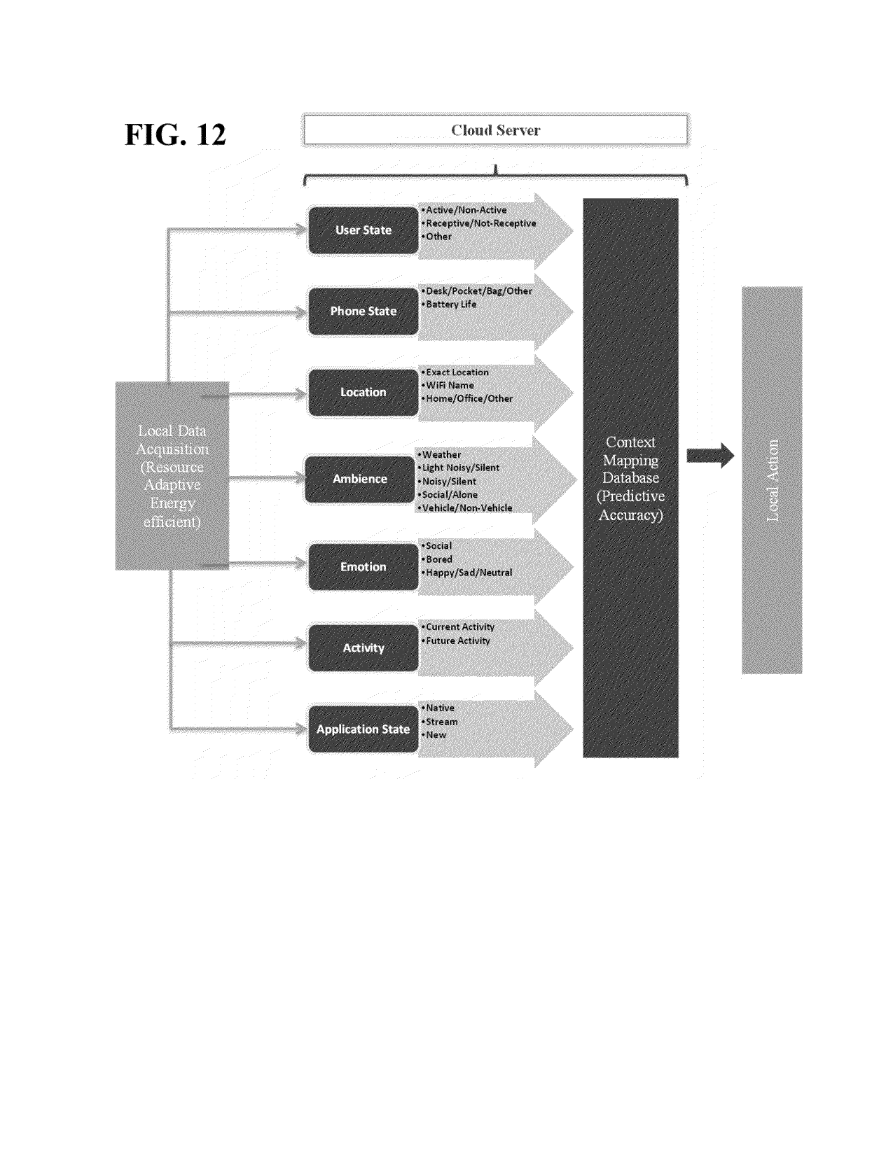

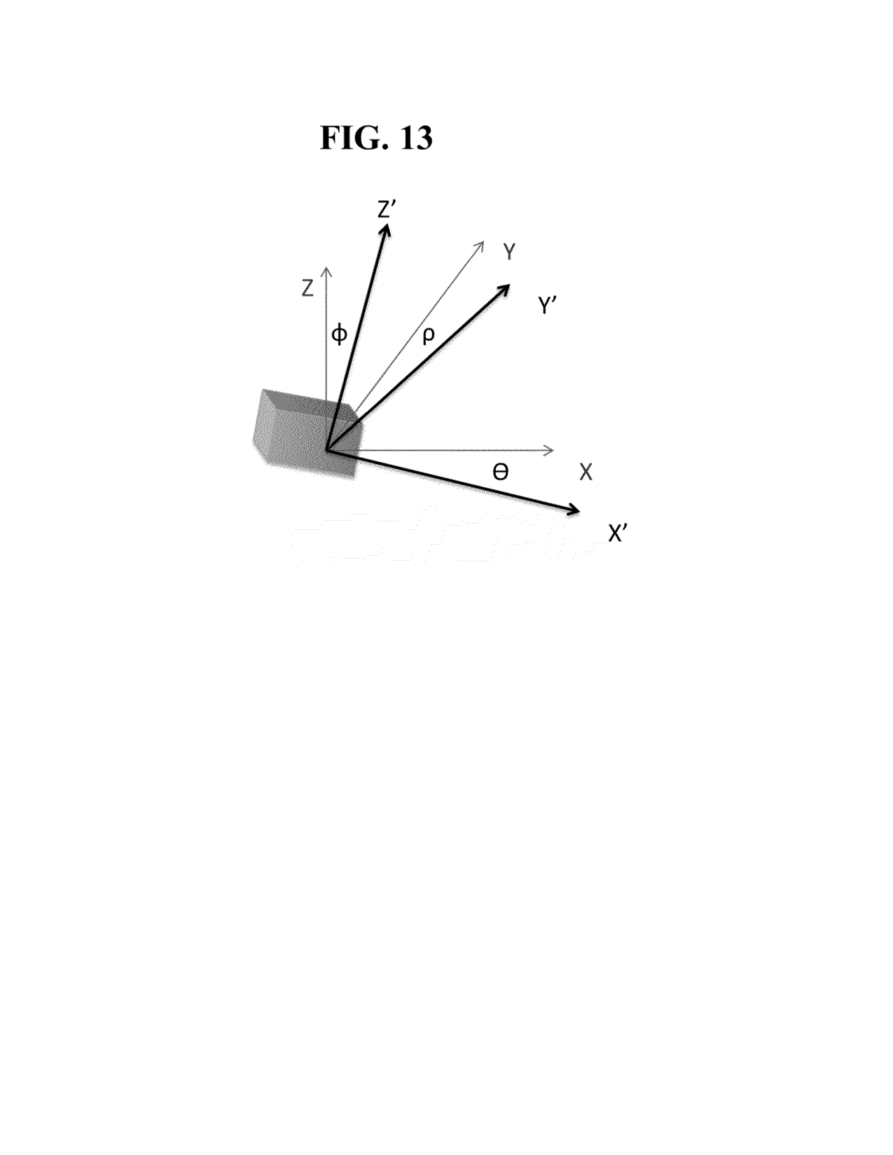

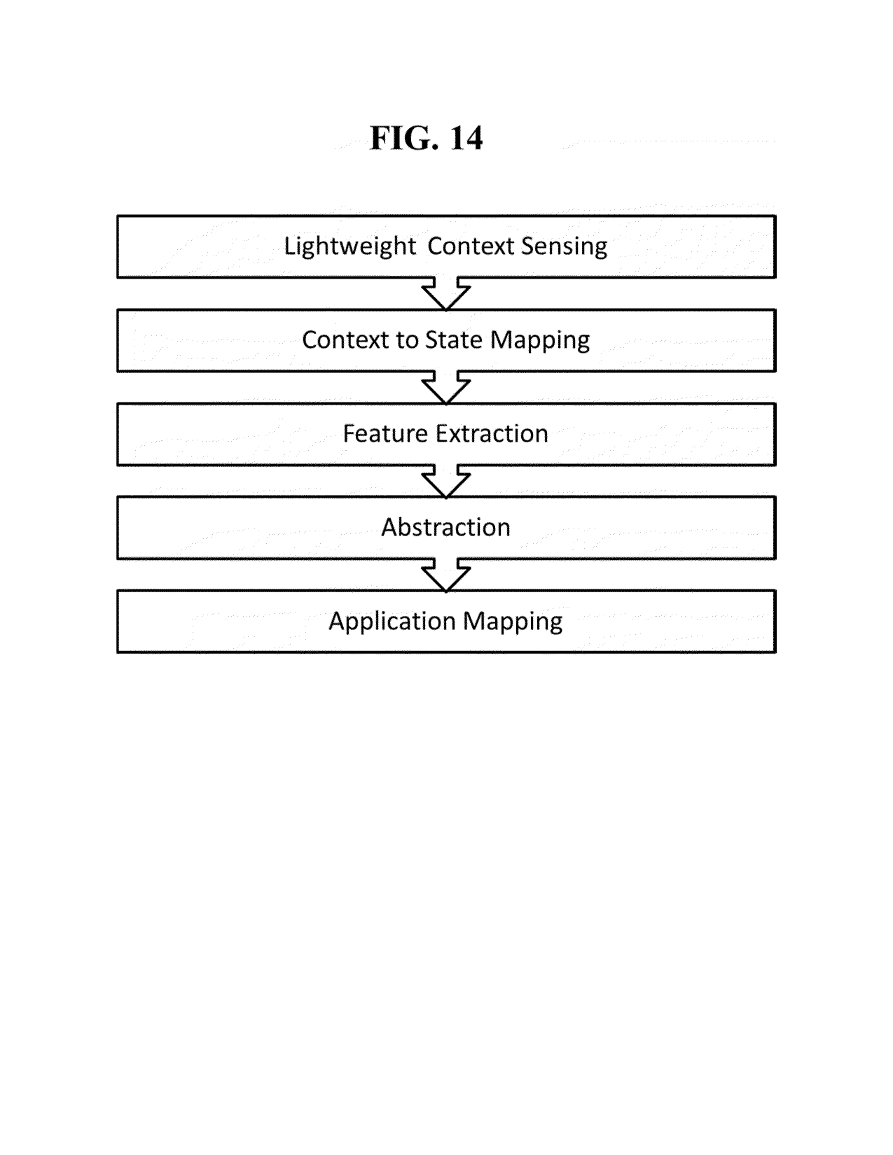

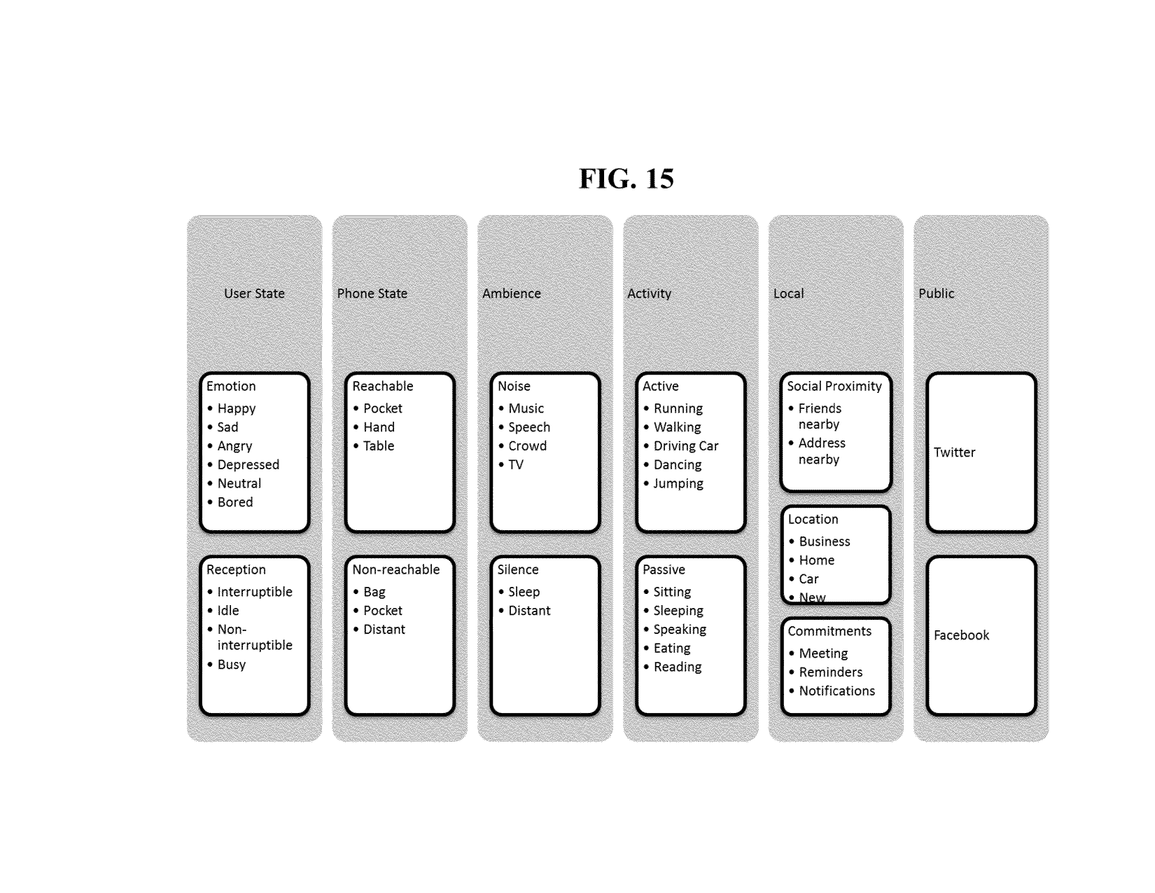

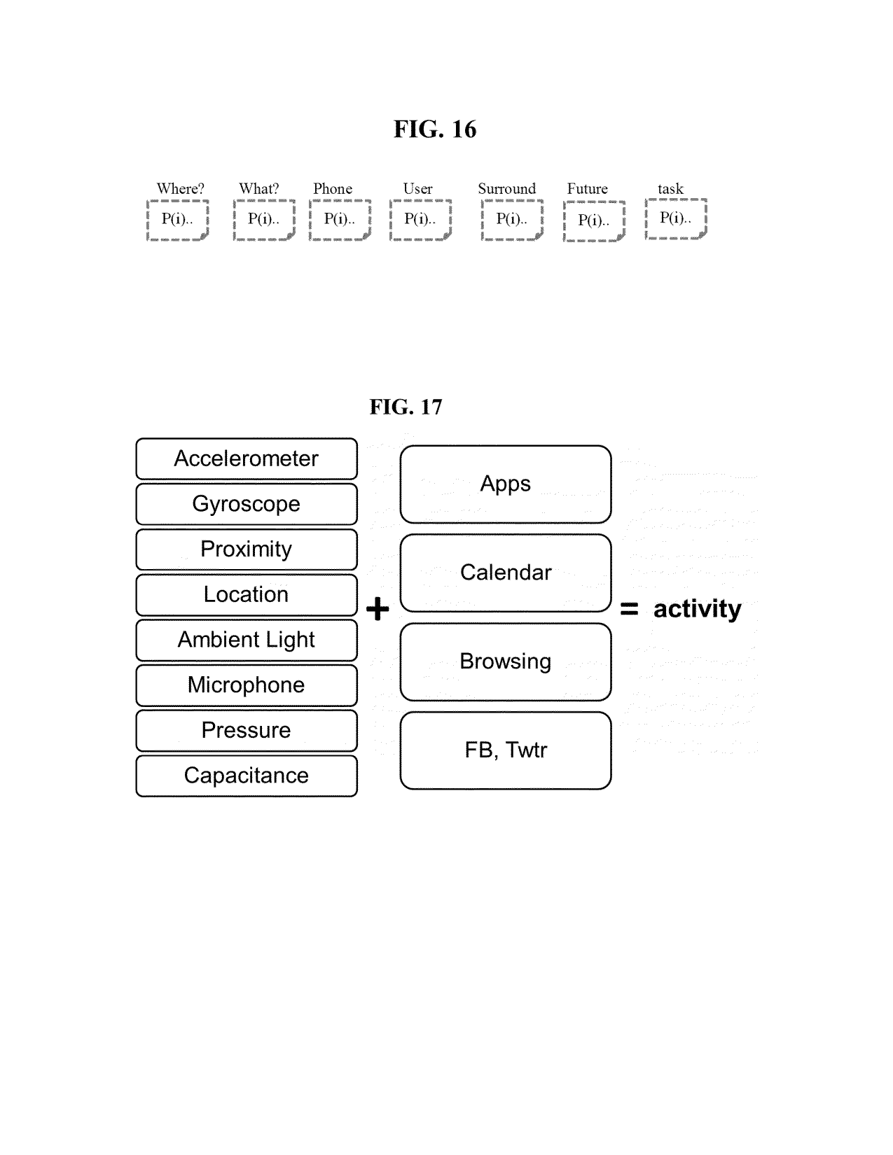

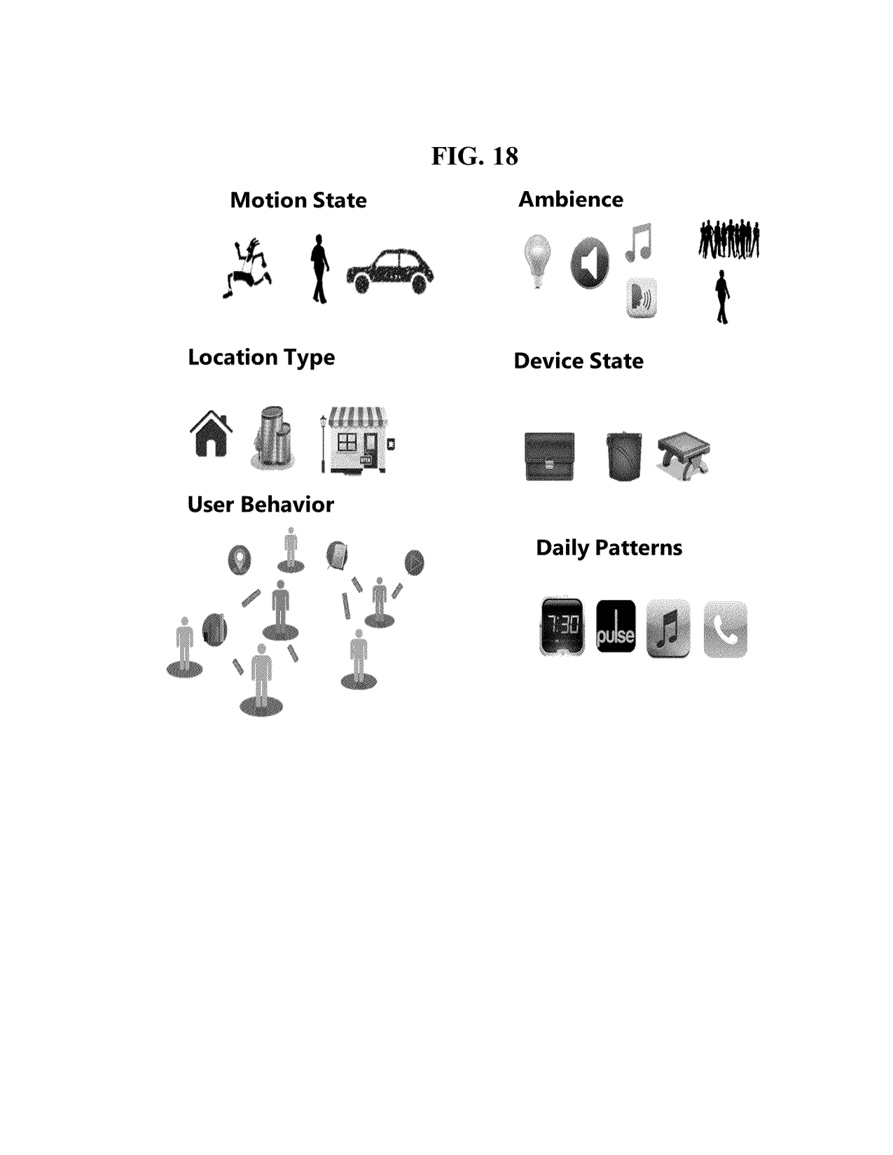

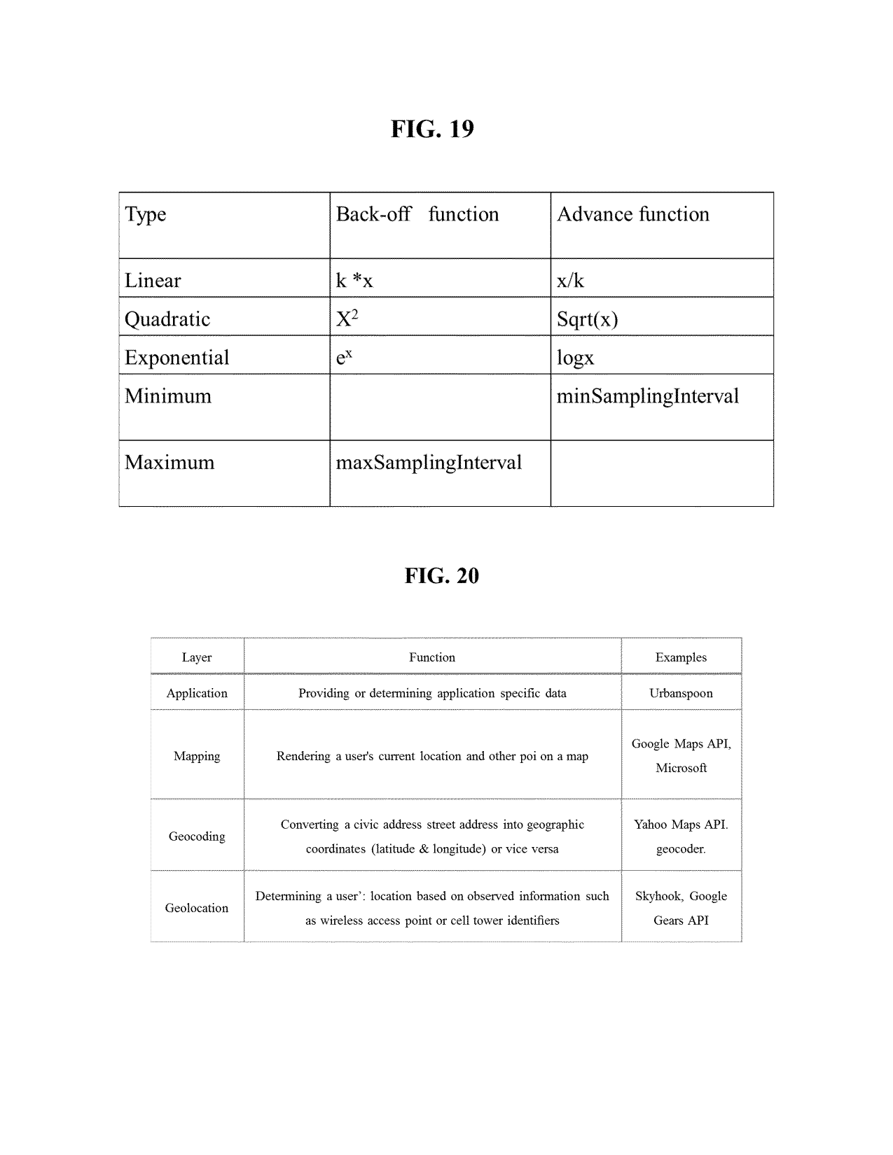

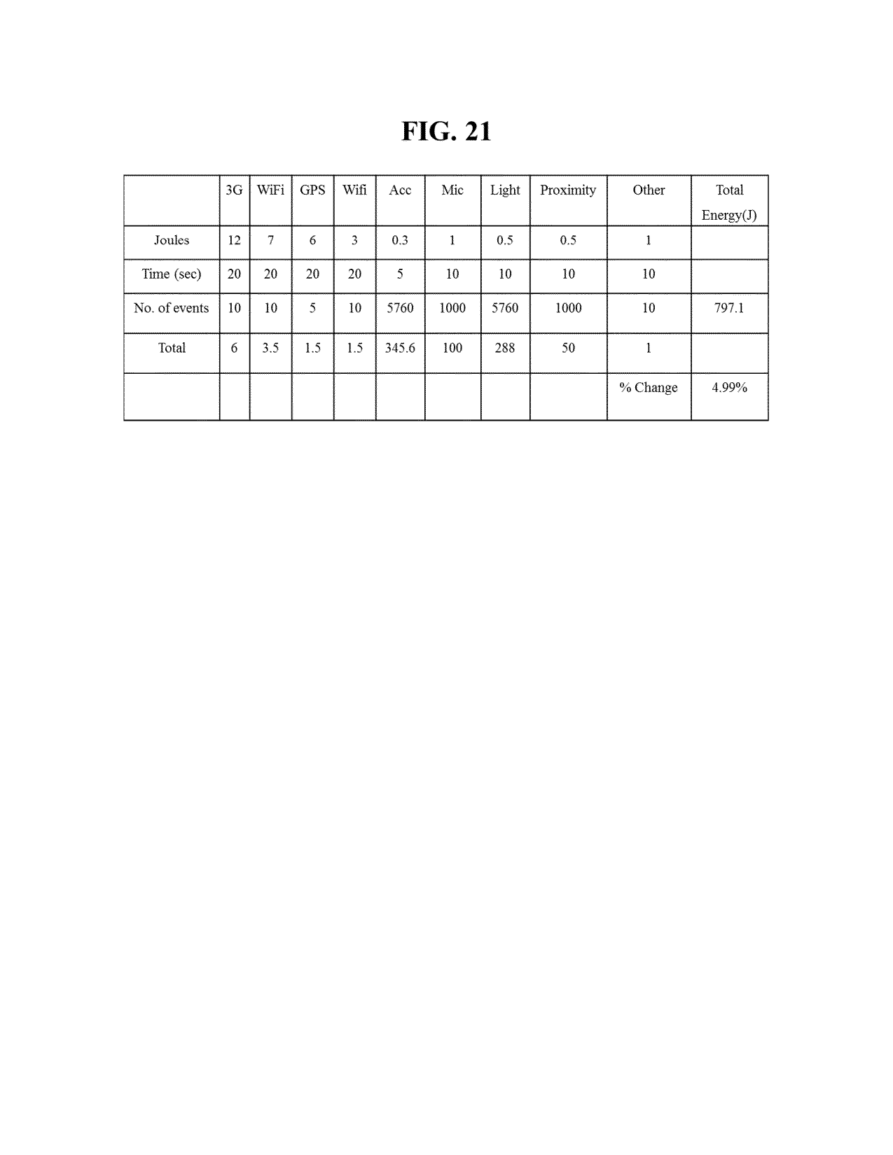

Accelerometer in smart phones is returns 3 current acceleration values in the units of m/s² along the x, y, and z axes. The schematic in FIG. 13 maps the co-ordinate directions on a smartphone. X-axis (lateral): Sideways acceleration (left to right) for which positive values represent the movements to the right whereas negative ones represent to the left. Y-axis (longitudinal): Forward and backward acceleration for which positive values represent forward whereas negative values represent backward. Z-axis (vertical): Upward or downward acceleration for which positive represents movements such as the device being lifted.

Current INVS/STMicro (more or less the same) accelerometers has dynamically user selectable full scales of ±2 g/±8 g (where g is the gravitational acceleration, g=9.81 m/s²), and it is capable of measuring accelerations with an output data rate of 1 Hz to 40 Hz. The digital output has 8-bit representation with each bit equaling to 18 mg. The configuration of sensor device on a typical android phone is set to ±2 g. Each reading of accelerometer sensor consists 3-D accelerations along X-axis, Y-axis, and Z-axis according to local coordinate system of current phone orientation.

What does this local mean? In the figure above a global coordinate system is shown as (X¹, Y¹, Z¹) and the local coordinate system based on phone's current orientation is shown as (X¹, Y¹, Z¹). There is a rotation (φ, ρ, θ) between these two coordinate systems.

Any inertial navigation system design should involve four different phases: calibration, alignment, state initialization, and current state evaluation. The output of the accelerometer is such that when the device is free falling in a vacuum, the chip will not detect any force exerted on the device, which will produce zeros for all three outputs.

We have to calibrate the device's accelerometer by placing it still on a horizontal plane parallel to the Earth's surface in order to achieve meaningful accelerometer readings.

When the device is lying flat, the accelerations in three axes of the device should be: ax=0, ay=0, az=−g

The g in the formula is the gravity of the Earth. Therefore, we use this assumption to calibrate by setting a coefficient offset:

The vector (xₘ, yₘ, zₘ) in the formula is the measured acceleration vector and (x_{c}, y_{c}, z_{c}) is the calibrated coefficient vector. The calibrated vector (x_{dev,} y_{dev}, z_{dev}) from the calibration phase will be used in the alignment phase.

The magnetic field should be measured by the digital compass chip inside the phone. It measures the strength of the magnetic field in the environment in micro tesla. The field varies from 30 μT (0.3 gauss) around the equator to approximately 60 μT near the north and south poles.

After the calibration phase, the output of the accelerometer is in the device's coordination system. With these outputs, we can only calculate distance, not displacement (useful for inertial navigation in the future). In order to work in the Earth's coordination system, we need to convert this output. To rotate the device's current coordination system to the Earth coordination system, we need to calculate a rotation matrix. The rotation matrix is calculated from the output of the accelerometer and the magnetic chip when the device is held still. When the device is not moving then it knows that the only force is gravity and how the gravity is distributed through the three axes of the device. This allows us to rotate the coordination in 3 dimensions so that the gravity is only pointing to one axis. After rotating the axis so that the z axis is pointing to the sky, we then incorporate the magnetic output to calculate rotation in the x and y axes.

This also assumes that only the Earth's magnetic field is affecting the device, which means that there are no other magnetic devices such as electrical wires or magnets nearby. If this assumption is true then we can rotate the current rotation matrix so that y-axis is pointing north and the x-axis is pointing east. The reason for using compass instead of inbuilt Gyroscope, at least for now is to eliminate power consumption.

The most important factor that contributes to an accurate rotation matrix is the input gravity from the accelerometer and the input geomagnetic field from the magnetic chip. The accuracy of the inputs determines accuracy of the output of our alignment phase. This process is continuous, which means that the device must compute a new rotation matrix whenever the phone is changing position. Therefore, whenever the device is rotated, the system needs a new Earth's gravity measurement and new Earth's magnetic field associated with the new position in order to compute a new rotation matrix. If the device is being held perfectly still, we can easily compute the rotation matrix with high accuracy. However, when a person is holding the phone, there will be a slight shaking from the hand of the person which adds acceleration to the output of the accelerometer other than just the Earth's gravity.

The method we use to detect whether the current acceleration consists of only gravity is by comparing the magnitude of the total calibrated acceleration at the current moment with the Earth's gravitational magnitude, which is 9.807 m/s². If this magnitude is within our error threshold of ±1 m/s², the Earth's gravity associated with current position is recorded. Besides the error that could result from the sensor itself, there is another problem that could potentially occur. If the person is moving at a rate such that the magnitude of total moving acceleration is offset in such a way that is in the gravity threshold then the system will mistake the acceleration as gravity, which then creates an inaccurate rotation matrix. The digital compass output data is filtered in a similar manner to filter out all the magnetic field data that is distorted by nearby magnets. The threshold value that we use is ±3 μT.

With the gravity and geomagnetic vectors measured in the phone coordinate system, the rotation matrix can be computed. The gravity vector ‘g’ and geomagnetic vector ‘e’ are first normalized.

And then we compute the horizontal vector H and momentum vector M from the normalized gravity and geomagnetic vectors. Finally, the rotation matrix is composed of three vectors g, m and h. The heading of the device in the Earth's coordinate system can also be computed from the rotation matrix.

### Motion Detection

Smartphones are likely to spend a significant fraction of their time stationary, during which time they cannot produce transit tracking data. Our system includes a simple low power detector for possible transitions away from stationary use. It can be thought of as a wake-up mechanism for the more sophisticated algorithms that run on the server side.

Our low power motion detector samples the accelerometer at 1 Hz, and continuously computes an exponentially weighted mean and standard deviation of the X, Y and Z accelerometer readings. If an incoming sample falls outside of three standard deviations on any axis, it reports “motion detected”. If the phone is static, the readings are more or less constant and lie within this band. Occasional false alarms

have a negligible effect, as the 20 Hz detector described below will quickly detect that no movement is taking place, and return to the stationary state and its low-power detector.

### Walking Detection

Walking detection based on accelerometer has been studied before, though under different circumstances.

Our walking detector uses a technique similar to that described before in a previous work (need to fill this). Raw accelerometer values, sampled at a moderate 20 Hz, are first made orientation-independent by computing the L2-norm (or magnitude described in introduction) |(a(x,y,z)| of the accelerometer readings. For a sliding window w, we then compute its discrete Fourier transform (DFT)

$$Mk = {\sum }_{n = 0}^{\vert w \vert - 1} mn {e}^{\frac{- 2 p i}{\vert w \vert}} kn$$

The magnitude of the DFT coefficients in frequency bands common to walking (1-3 Hz) are used as features for classifying a walking activity. To improve accuracy we introduce an additional feature: peak frequency power. This feature is independent of the speed of walking, and captures some of the cases where the fundamental frequency (of walking) is not the peak frequency, due to placement dependent jiggling or bouncing effects.

### Vehicular Motion Detection

Detecting vehicular mobility by accelerometer serves two purposes: (a) as an energy conserving mechanism for triggering GPS localization only when in a vehicle, and (b) as

input to our inertial navigation system. Using the accelerometer as input, we estimate the probability that vehicular mobility is in progress. This algorithm expects accelerometer input from periods of stationary use, or vehicular movement. Our highly accurate walking detector is used to filter out periods of walking.

We model the two distributions of acceleration samples in the moving and stationary state as Laplace distributions, with probability density function

Given these probability density functions, we use Bayes' theorem to compute the probability that a sample x came from the moving distribution.

### Sound Classification: Noise, Music, Speech

The script works by recording a real time audio clip using microphone sensor and then the recorded sound clip will go through two classification steps. First, by measuring the energy level of the audio signal, the mobile is able to identify if the environment is silent or loud. Note that the energy E of a time domain signal x(n) is defined by

E =Σ|x(n)2|. Next, if the environment is considered loud, both time and frequency domains of the audio signal are further examined in order to recognize the existence of speech. Specifically, speech signals usually have higher silence ratio (SR) (SR is the ratio between the amount of silent time and the total amount of the audio data) and significant amount of low frequency components. If speech is not detected, the background environment will simply be considered as “loud” or “noisy” and no further classification algorithm will be conducted to distinguish music, noise and other types of sound due to their vast variety of the signal features compared to speech.

SR is computed by picking a suitable threshold and then measuring the total amount of time domain signal whose amplitude is below the threshold value. The Fast Fourier Transform has been implemented such that the mobile device is also able to conduct frequency domain analysis to the sound signal in real time. It can be seen clearly that as compared to others, speech signals have significantly more weight on low frequency spectrum from 300 Hz to 600 Hz. In order to accomplish speech detection in real time, we have implemented the SSCH (Sub band Spectral Centroid Histogram) algorithm on mobile devices. Specifically, SSCH passes the power spectrum of the recorded sound clip to a set of highly overlapping band pass filters and then computes the spectral centroid 1 on each sub band and finally constructs a histogram of the sub band spectral centroid values. The peak of SSCH is then compared with speech peak frequency thresholds (300 Hz-600 Hz) for speech detection purpose.

### Battery Duty-cycle Back-off/Advance Function

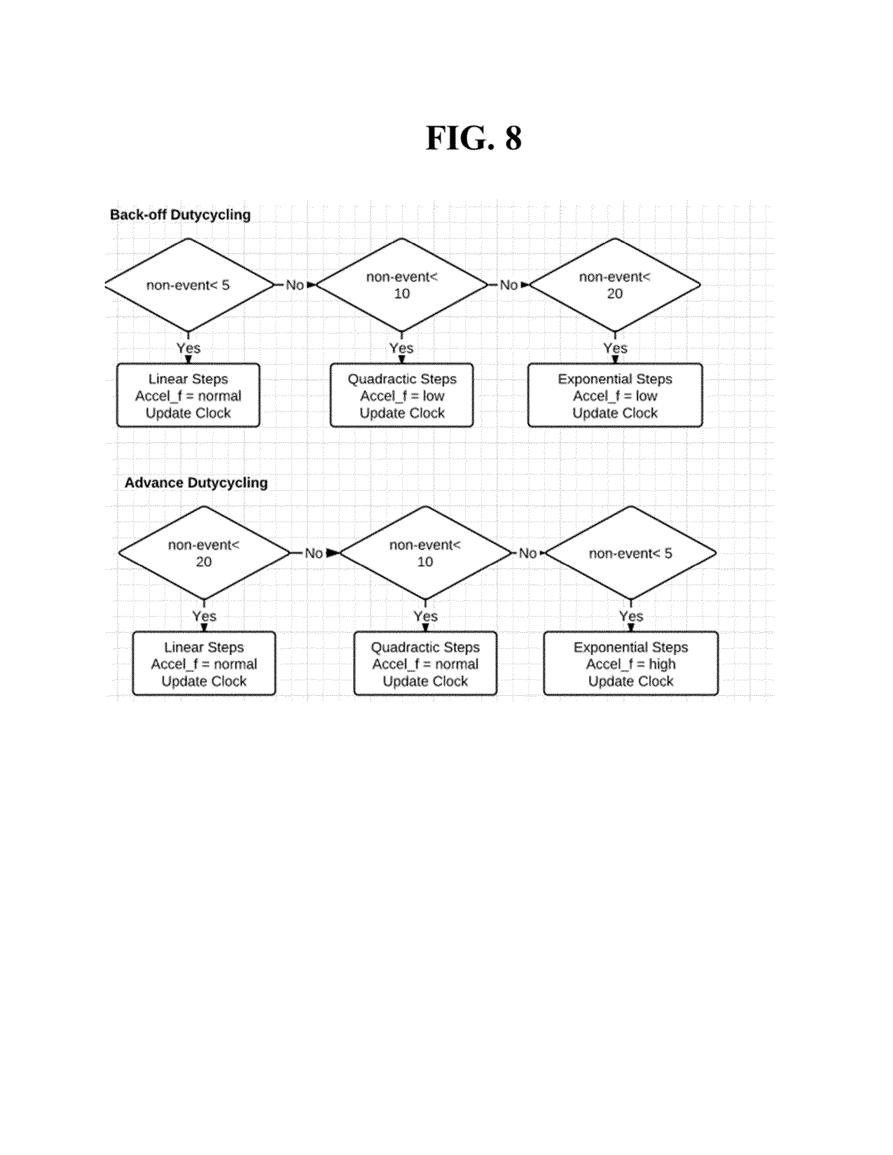

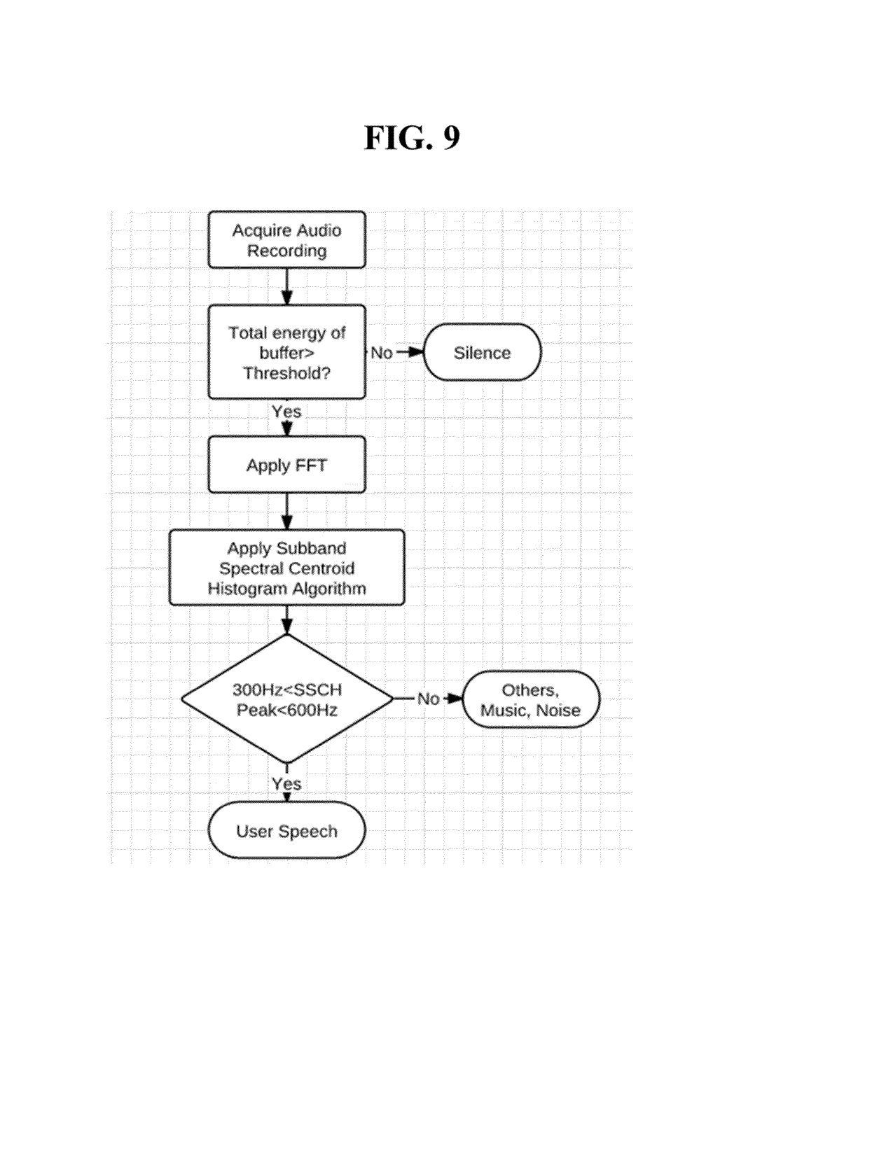

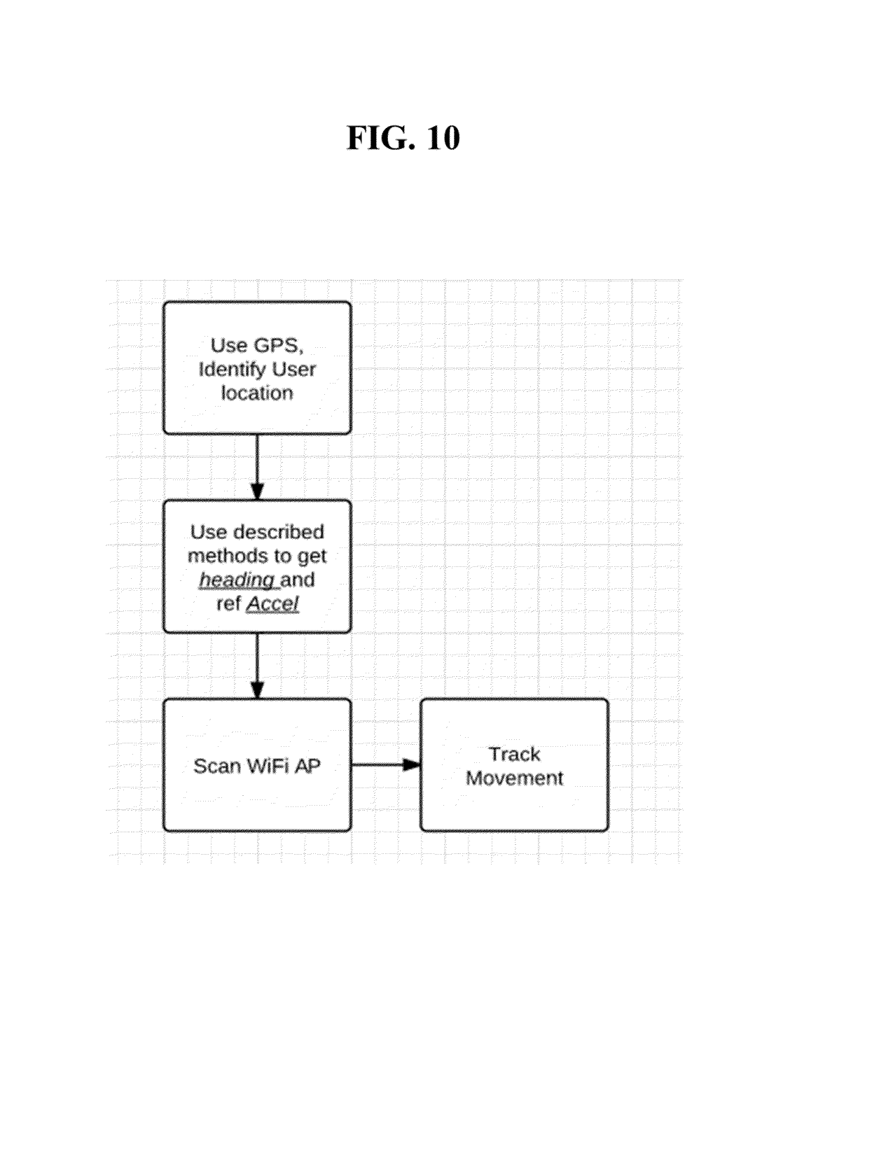

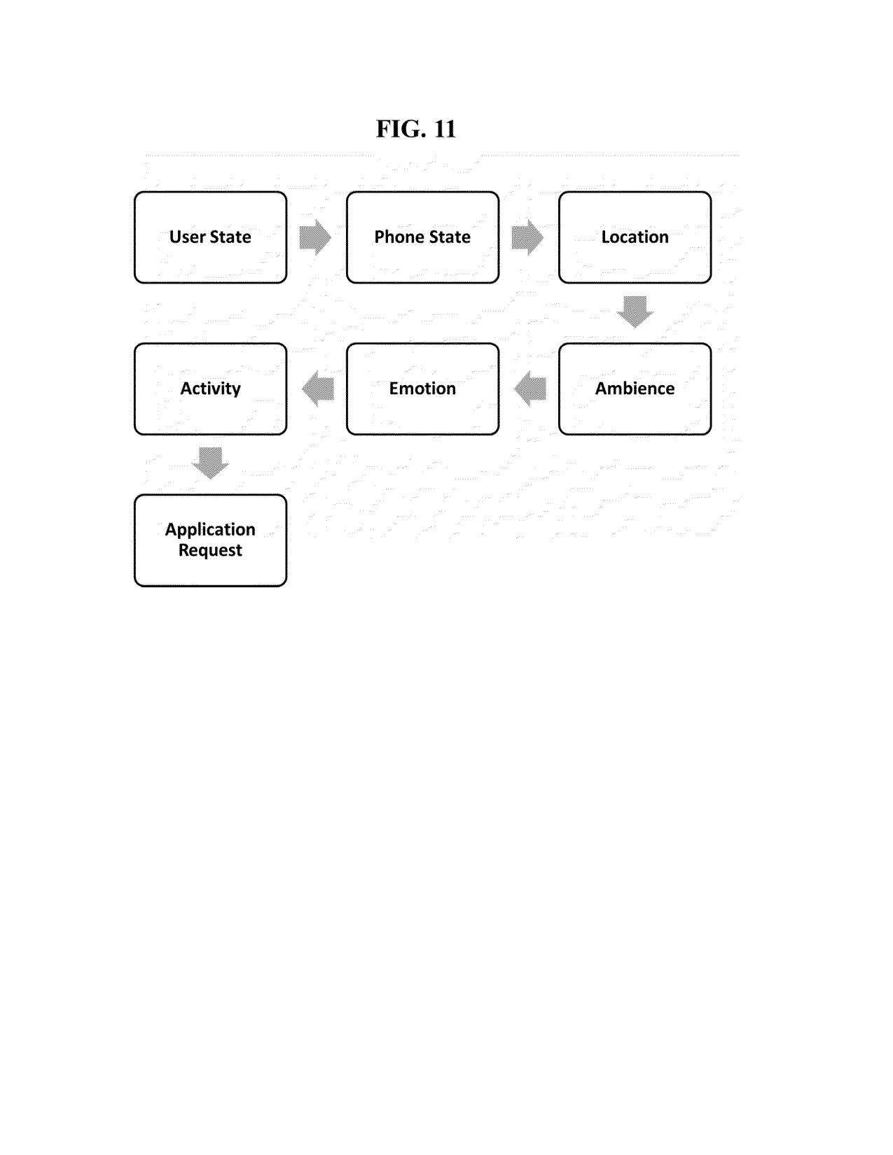

Algorithm shown in FIG. 8 is used to set the frequency and interval time for accel sensing and rest periods. Linear sensing is done at 1 Hz. Any other function is done at 20 Hz.

### Location Identification Class

Identify the accurate location and precise location of the user. 4 methods provide location information;
1. Looking up WiFi AP's BSSID in database mapping BSSID to location. (fast, reliable)
2. Cellular geolocation through cell tower ID
3. GPS built on the phone
4. Motion tracking using GPS, Wifi last point with Compass, Accelerometer in the phone

Third party location services are as shown in Fig.

Generic location: At a store, at office, at home, at a theatre, at engineering bldg., hospital.

It is possible to identify a physical location based on Google gears API, GeoCoding, matching Wifi name and signal strength with local stores. Home and office can be registered on the day of first usage.

Specific/Indoor location: In bedroom, In cinema hall #3, Near checkout counter, At aisle 3, in conference room, class room #6, operation theater.

The approach here depends on use case. At home and office, pattern based and ambient sensing based approach should be taken. At specified locations, like campus, libraries and local points of interest web based crawling is done to display results in a meaningful way. At malls, Indoor navigation can be done by using built in accelerometer, compass and gyro. However, a map overlay has to be done to figure out destination/exact location indoor. Third party apps like Point Inside, Micello can be streamed while in registered local malls.

### Application Delivery

An App is a packaged collection of software entities. The packaging follows a well-defined protocol in arranging the constituent entities inside the App. Streaming an App starts with unpacking the App package followed by reading the catalog of all the entities in the package. The catalog of items specifies the entities that are required to perform actions of the App on a device, security features, permissions and presentation layout information of the App. In the next step, analyzing the catalog and the entities is done to select and pick which components of the App are required to be able to execute the Apps' initial functionality. Depending on the App analysis, all or some of the entities are selected for sending to the device. The entities are packaged into a sub group and streamed into the devices' internal memory. Upon receiving the requested Apps' package, main App invokes its App-Stream-Opener component, which is used for unpacking and executing the received App. The App-Stream-Opener is a software entity, that builds a application execution environment to facilitate execution of Apps that are not locally available on the phone. The execution environment is built for:
1. Pre-initializing all the devices' hardware resources required by the streamed app (gathered during analysis of the Apps' catalog),
2. Setting up local memory locations on device to store Apps' entities like images, presentation layout configurations, audio/video content.
3. Initializing software interfaces to enable the received app to use/fetch/invoke other software components/Apps available on the device that are provided outside of software on the device (main app).
4. Securing the received App from other software/hardware components on the device.
5. Protect and isolate execution of the received app within the security configurations/permissions granted to software on the device (main app).
6. Monitor actions performed by the streamed App entities.

Depending on the interaction of the user with the received App, the execution of the App is closely monitored. If the set of entities of the App streamed to the device do not make the complete set of entities of the App at the remote location, then the above monitoring by the execution environment senses any execution patterns that require entities of the App, that are not already streamed on to the device. Then the layer initiates a server request with details regarding the App being executed, its current action, a catalog of additional entities required to continue the execution the App on the device. The server fetches the App and the set of entities requested from it and streams them to the requesting device. Once the additional entities are received, the app execution continues on the device. The execution environment ensures that the on-demand streaming of additional components while execution does not cause failure or modify the actual functionality of the streamed App compared to its execution on a device where it is locally available. Any streamed-in App can be made to be available locally on the device for serving further invocation requests by the user without streaming it in every time. Likewise, any App that is streamed-in may be evicted from the device, upon request by the user or by software on the device (main app), when deemed unnecessary to keep it locally available. This can happen in cases where the streamed-in App is no longer relevant to the user/device or when the App has been updated on the server or when the local memory needs to be freed up for other purposes.

The inventions as shown and/or described and the applications mentioned above but not limited exclusively to those applications:

We claim

1. A mobile device with a native or installed mobile application that communicates with a cloud platform for context based content delivery to the mobile terminal device.
a. The mobile cloud platform described in claim 1, which includes,
b. a mobile cloud virtualization layer,
c. a mobile cloud content delivery layer and
d. a mobile cloud network layer.

2. The mobile cloud platform described in claim 1, which includes a
a. mobile cloud virtualization layer functions as a storage and process center. It allocates resources for native applications and other user information storage, content storage for static services, content storage for dynamic services and runs application processes for mobile users independent of the mobile platform.
b. The mobile cloud content delivery layer runs a context-adaptive engine that delivers service provider content to a mobile platform based on space-time context of the user.
c. The mobile cloud network layer forms dynamic local networks as well as high frequency usage networks with other mobile terminal devices based on the user analytical data.

3. A mobile application layer on a device, which does all or some of the following:
a. Gather contextual information from device using device sensors and user generated data,
b. Processes the data on the server; invokes appropriate service on the device

4. A mobile application layer, which ranks users intentions on a value scale and recommends appropriate service/product to the user based on contextual sensing

5. A mobile software which streams an application from the server and performs some or all of these:
a. Pre-initializing all the devices' hardware resources required by the streamed app (gathered during analysis of the Apps' catalog),
b. Setting up local memory locations on device to store Apps' entities like images, presentation layout configurations, audio/video content.
c. Initializing software interfaces to enable the received app to use/fetch/invoke other software components/Apps available on the device that are provided outside of software on the device (main app).
d. Securing the received App from other software/hardware components on the device.
e. Protect and isolate execution of the received app within the security configurations/permissions granted to software on the device (main app).
f. Monitor actions performed by the streamed App entities.

6. A mobile software which gathers contextual user information and recommends appropriate service or application to user
